(19) United States
(12) Patent Application Publication
(10) Pub. No.: US 2003/0078980 A1
(43) Pub. Date: Apr. 24, 2003

(54) Electronic billboard for peripheral devices

(76) Inventors: Jay Carstens, Washougal, WA (US); Todd A. Fischer, Boise, ID (US); Robert Sesek, Meridian, ID (US); Travis J. Parry, Boise, MD (US)

Correspondence Address: HEWLETT-PACKARD COMPANY, Intellectual Property Administration, P.O. Box 272400, Fort Collins, CO, 80527-2400, US

(21) Appl. No.: 10/035,794

(22) Filed: Oct. 18, 2001

(51) Int. Cl. G06F 15/16

(52) U.S. Cl. 709/206

(57) ABSTRACT

A peripheral device operable to be coupled to a computer communication network and deliver electronic content information includes a content delivery device and a content delivery module. The content delivery device is operable to deliver electronic content information. The content delivery module is coupled to the content delivery device and operable to retrieve the electronic content information. The content delivery module is further operable to determine an appropriate time to deliver the electronic content information, and to deliver the electronic content information via the content delivery device. A method of delivering electronic content information through a peripheral device includes: retrieving electronic content information; determining when a content delivery device coupled to the peripheral device is idle; and responsive to determining that the content delivery device is idle, delivering the electronic content information via the content delivery device.

### BACKGROUND

1. Field

The present invention relates generally to content delivery systems, and in particular, to an electronic content delivery through peripheral devices.

2. Description of the Related Art

In an office setting, by way of example, peripheral devices such as printers, fax machines, and copiers, are used by more than one person. For example, a printer may be coupled to more than one computer via a network server. Since the peripheral device is shared among users, it is usually located in a place that is accessible to the users. Furthermore, common users tend to congregate around shared peripheral devices, awaiting their print job or awaiting their turn to photocopy or fax a document, or receive a fax.

A peripheral device typically has a content delivery device, such as a display screen, that reports the status of the associated or coupled peripheral device. The display screen coupled to a printer may show status reports such as “printing,” “out of service,” “out of paper,” “paper jam,” and the like. Similarly, a copier, for example, may show status reports on the display screen such as “copying,” “out of service,” “out of paper,” “paper jam,” and the like. A fax machine, for example, may show status reports on the display screen such as “receiving fax,” “sending fax,” and the time of day.

While the display screen is useful for providing status reports to users, it is not useful when it is idle. A display screen is idle, by way of example, when the peripheral device is not being used to convey information, when no error messages are displayed on the screen, or when a continuous status message, such as “online,” “printing,” etc., is displayed on the screen. Since the display screen is idle most of the time, the peripheral device is not being efficiently used. Hence, there is a need to better utilize peripheral devices to deliver electronic content, especially while the coupled content delivery devices are idle.

### SUMMARY

The present invention provides an electronic billboard for peripheral devices. The peripheral device includes a content delivery device and a content delivery module. The content delivery device delivers electronic content information. By way of example, the content delivery device can be a display screen or a speaker, or both. The content delivery module retrieves or receives the electronic content information for delivery via the content delivery device. The content delivery module can also determine the appropriate time to deliver the electronic content information, and submits the electronic content information for delivery via the content delivery device. The appropriate time for delivery, for example, is when the content delivery device is idle.

The electronic content information can be retrieved from a remote content server or a local storage unit. Moreover, the electronic content information delivered may be general information, targeted information, or user specified information. For example, user identification can be used to identify a specific user of the peripheral and the electronic content information targeted to that user. The user identification can further be used to determine the user's accounting information, for example, for ordering products or services. As another example, a user identification can be detected using a sensor module coupled to the content delivery module.

A user identification can also be determined from a requested job (e.g., a task that is being performed by the peripheral device). For instance, when the user requests a print job, the content delivery module coupled to a network server can determine the user identification based on the network protocol or logon information. Alternatively, a user identification may be entered, by way of example, using an input device such as a keypad, touch screen, or voice command recognition device, that is coupled to the content delivery module. The input device may also be used in other applications, for example, requesting the delivery of the electronic content information via electronic or paper medium, selecting alternative electronic content information for delivery, and ordering products or services offered via the content delivery device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a peripheral device operable to be coupled to a computer communication network includes a content delivery device and a content delivery module. The content delivery device is operable to deliver electronic content information. The content delivery module is coupled to the content delivery device and operable to retrieve the electronic content information. The content delivery module is further operable to determine an appropriate time to deliver the electronic content information, and to deliver the electronic content information via the content delivery device.

In another embodiment, a peripheral device operable to be coupled to a computer communication network includes a content delivery device operable to deliver electronic content information. The peripheral device also includes a first means for determining an appropriate time to deliver the electronic content information, and a second means for retrieving the electronic content information. The peripheral device further includes a third means for delivering electronic content information via the content delivery device.

In still another embodiment, in a peripheral device, a method of delivering electronic content information includes: retrieving electronic content information; determining when a content delivery device coupled to the peripheral device is idle; and responsive to determining that the content delivery device is idle, delivering the electronic content information via the content delivery device.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

FIG. 1 illustrates an exemplary environment in which one embodiment of the invention may operate.

FIG. 2 illustrates an exemplary content table, according to one embodiment.

FIG. 3 illustrates an exemplary device table, according to one embodiment.

FIG. 4 illustrates an exemplary user table, according to one embodiment.

FIG. 5 illustrates a flow chart of an exemplary method for delivering electronic content information through a peripheral device, according to one embodiment.

FIG. 6 illustrates a flow chart of an exemplary method for delivering electronic content information based on user identification, according to one embodiment.

FIG. 7 illustrates a flow chart of an exemplary method for delivering electronic content information based on the content of a printed document, according to one embodiment.

FIG. 8 illustrates a flow chart of an exemplary method for delivering electronic content information based on device identification, according to one embodiment.

FIG. 9 illustrates a flow chart of an exemplary method for delivering electronic content information based on detecting a user, according to one embodiment.

FIG. 10 illustrates a flow chart of an exemplary method for providing a copy of the electronic content information, according to one embodiment.

FIG. 11 illustrates a flow chart of an exemplary method for ordering a product or service, according to one embodiment.

### DETAILED DESCRIPTION

A system and corresponding methods, according to an embodiment of the present invention, facilitate the delivery of electronic content information via a content delivery device coupled to a peripheral device. Peripheral devices, such as, by way of example, printers, fax machines, copiers, digital audio players, video players, display boards, electronic project equipment, and telephones are equipped with content delivery devices such as display screens. A display screen provides device status reports such as paper jam, printing, copying, faxing, and the like. Although the display screen is useful for providing status reports on the peripheral device, it is not useful when it is idle. A display screen is idle, by way of example, when the peripheral device is not being actively used to convey information, when no error messages are displayed on the screen, or when a continuous status message is displayed on the screen.

In one embodiment, a peripheral device, and in particular, a coupled content delivery device provides more than just status information. The content delivery device can, by way of example, display electronic content information such as advertisements, corporate communication, device specific information, and personal real-time information. Corporate communication may include company announcements, training lessons, or reminders for appointments, deadlines, etc. Device specific information not only includes status reports, but may also include information on features or accessories for upgrading the peripheral device; information on operating the peripheral device; and information on features not often used in the peripheral device. Personal real-time information may include information that is specific or tailored for a particular user and includes information such as, by way of example, current stock prices, news, priority email, calendar information, etc.

The electronic content information delivered may be general information, targeted information, or user specific information. The type of electronic content information may be specified or determined by sources such as, by way of example, a user of the peripheral device (e.g., a company using the peripheral device, individual users of the peripheral device, and the like), the manufacturer of the peripheral device, or a third party provider of electronic content information. General information may include generic information such as banner advertisements that are arbitrarily determined regardless of the type of peripheral device or the type of peripheral device user. Targeted electronic content information may be determined based on the location of the peripheral device, type of peripheral device, or document contents (e.g., the document or task being processed by the peripheral device).

Electronic content information based on location may include information generally targeted for types of users at or in the proximity of the peripheral device. For example, a peripheral device located within an engineering department (e.g., for use primarily by engineers located near the peripheral device) may deliver electronic content information targeted for engineers. In contrast, a peripheral device located within a sales department (e.g., for use primarily by sales persons located near the peripheral device) may deliver electronic content information targeted for sales people. Electronic content information based on location may also include information targeted for a specific company. For instance, a peripheral device used by company “A” delivers electronic content information suitable for company “A” while a peripheral device used by company “B” delivers electronic content information suitable for company “B.”

Electronic content information based on type of peripheral device may include information appropriate for the particular peripheral device. The electronic content information may be determined based on the peripheral device make and model, such as, by way of example, operating instructions, service information, related product information, etc. Electronic content information may be based on the contents of a document or “job” that is being processed by a peripheral device. For example, a printer can determine that it is printing, or about to print, a legal document and from this information, deliver electronic content information that is related to or suitable for the legal profession (e.g., information regarding legal products and services).

Electronic content information may also be determined based on a person's user identification. In one embodiment, the user identification can be detected using a sensor component of the peripheral device. The sensor component can conform to the Bluetooth specification or another wireless specification. Articles, such as mobile phones, pagers, cameras, watches, electronic ID cards or access cards, and other portable electronic devices, can be equipped with a communication component that is capable of communicating with the sensor component to transmit a user's identification. The peripheral device can retrieve, for example, from a remote content server or local storage, the electronic content information based on the user identification. The peripheral device can then display the electronic content information, for example, via the coupled content delivery device.

In another embodiment, the user identification is determined from a requested job. For example, a user may use his or her personal computer to submit a print request to a coupled printer (i.e., the peripheral device). The print request may be a request to print a document (i.e., the requested job). The protocol used in submitting the print request can include the user identification information. When the printer receives the print request, the printer can determine the user identification information from the protocol, and use the user identification to retrieve and deliver electronic content information suited for the particular user identification.

In still another embodiment, the user identification is entered using, by way of example, an input device such as a keypad, a touch screen, or voice command recognition device, that is coupled to the peripheral device. For example, the peripheral device can request that a user enter a user identification and a password. The user can provide this information by entering it through the coupled input device. The peripheral device can retrieve and deliver electronic content information associated with the user identification.

In yet another embodiment, the input device can receive other input information. By way of example, the input device may allow a user to request the delivery of the currently or just displayed electronic content information on a paper medium or via email. For example, the user can request and obtain a paper copy of an advertisement, coupons for products and services, company brochures, and other information shown on a display device coupled to a peripheral device. The input device may also allow the user to select alternative electronic content information for delivery. For example, a user can specify the type of electronic content information that he or she may be interested in, such as, stocks information, world news, financial news, sports news, calendar information, and the like. The user may be provided one or more menus, for example, as part of the peripheral device configuration utility, through which the user can specify this information. The peripheral device can display a list of the user specified categories when or while processing any tasks or jobs for the user, and the user can select the category of electronic content information from the displayed list. Alternatively, the peripheral device can display, for example, in a round-robin or alternating fashion, the electronic content information of the type specified by the user while or substantially during the time it is processing a task for the user.

The input device may allow the user to order products and services. For example, a peripheral device may display an offer for a product or service and provide an option for a user to purchase the displayed offer. A user can subsequently select, for example, by selecting an option through a coupled keypad, an option to purchase the displayed offer. The peripheral device can then request payment information. In one embodiment, the user can provide credit or debit card information and the peripheral device can accordingly charge the credit or debit card the cost of the purchase product or service. In another embodiment, the user can provide user identification or other accounting information (e.g., department charge number, etc.). The peripheral device can retrieve from a remote content server or local storage unit, the accounting information associated with the user identification. The peripheral device can then use the accounting information to accordingly bill the user for the purchased product or service.

In addition, the input device may allow the user to activate or deactivate the delivery of electronic content information. For instance, if the user is not interested in receiving electronic content information, the user can deactivate its delivery.

In one embodiment, a peripheral device may superimpose the status report of the peripheral device over the electronic content information. This prevents the delivery of electronic content information from interrupting any status reports. In another embodiment, a display screen coupled to a peripheral device may have a first section for viewing status reports and a second section for viewing the electronic content information.

In still another embodiment, a peripheral device can deliver electronic content information based on the contents of a document that is being processed by the peripheral device. For example, when printing a document, a printer can determine the document's content type (e.g., by parsing or scanning the document contents for key words and/or phrases), retrieve electronic content information based on the content type, and deliver the electronic content information, for example, through a coupled delivery device.

In yet another embodiment, a peripheral device can deliver electronic content information based on the document type (i.e., based on the type of document). For example, the document may be associated with a filename having a particular filename extension (e.g., doc., .pdf, .xls, .vsd, etc.). The peripheral device can determine the electronic content information to deliver based on the document filename or filename extension.

Nomenclature

The detailed description that follows is presented largely in terms of processes and symbolic representations of operations performed by conventional computers. A computer may be any microprocessor or processor (hereinafter referred to as processor) controlled device, including terminal devices, such as personal computers, workstations, servers, clients, mini-computers, main-frame computers, laptop computers, a network of one or more computers, mobile computers, portable computers, handheld computers, palm top computers, set top boxes for a TV, interactive televisions, interactive kiosks, personal digital assistants, interactive wireless devices, mobile browsers, or any combination thereof. The computer may possess input devices such as, by way of example, a keyboard, a keypad, a mouse, a microphone, or a touch screen, and output devices such as a computer screen, display, printer, or a speaker. Additionally, the computer includes memory such as a memory storage device or an addressable storage medium.

The computer may be a uniprocessor or multiprocessor machine. Additionally, the computer, and the computer memory, may advantageously contain program logic or other substrate configuration representing data and instructions, which cause the computer to operate in a specific and predefined manner as, described herein. The program logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The program logic conventionally includes the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art to effectively convey teachings and discoveries to others skilled in the art.

The program logic is generally considered to be a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computer.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hard-wired logic or programs stored in non-volatile memory, such as read-only memory (ROM).

Overview

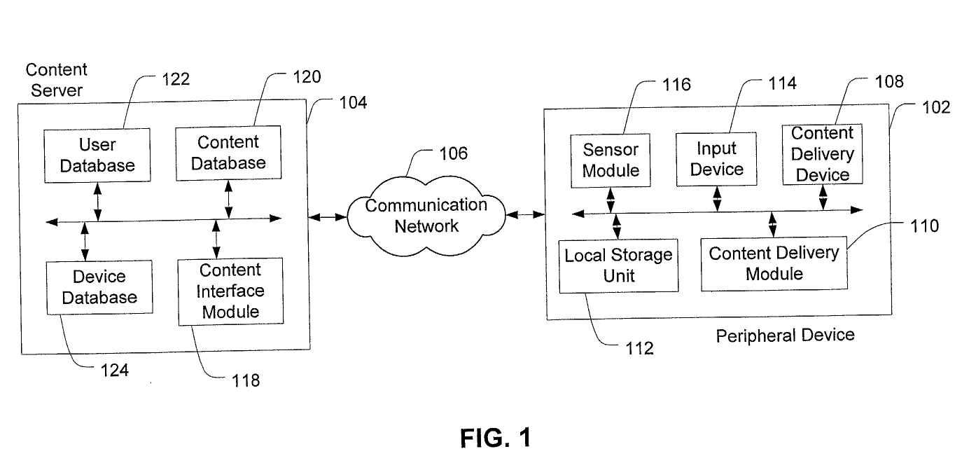

FIG. 1 illustrates an exemplary environment in which one embodiment of the invention may operate. As illustrated, the environment includes a peripheral device 102 and a content server 104 both coupled to a communication network 106. As used herein, the terms “connected,” “coupled,” or any variant thereof, means any connection or coupling, either direct or indirect, between two or more elements; the coupling or connection between the elements can be physical, logical, or a combination thereof. Also, as used herein, the term “server” is to be viewed as designations of one or more computers and is not to be otherwise limiting in any manner. The server may, by way of example, be comprised of one or more modules that execute on one or more computers. Furthermore, the server can comprise one or more modules that execute on one or more computers.

Peripheral device 102 facilitates the retrieval and delivery of electronic content information. In particular, peripheral device 102 includes a content delivery device 108, a content delivery module 110, a local storage unit 112, and a sensor module 116. Content delivery device 108 delivers electronic content information, such as status reports, corporate communication, advertisements and personal real-time information. By way of example, content delivery device 108 can be a display screen or a speaker, or any combination of screens and speakers.

Content delivery module 110 contains program logic to communicate with one or more modules or components of peripheral device 102 and content servers 104 to retrieve and/or receive, and deliver electronic content information. Content delivery module 110 also contains program logic to determine the appropriate time to deliver the electronic content information. For example, the appropriate time for delivery can be when content delivery device 108 is idle. Moreover, content delivery module 110 contains program logic to process the ordering of products and services that are offered through peripheral device 102.

In one embodiment, content delivery module 110 contains program logic to retrieve electronic content information from one or more content servers 104 through communication network 106. Content delivery module 110 can transmit a request for the electronic content information. Subsequently, content delivery module 110 receives the electronic content information from content server 104 and submits the electronic content information for delivery by content delivery device 108 upon determining, for example, that content delivery device 108 is idle and thus, capable of delivering the electronic content information.

In other embodiments, content delivery module 110 can receive electronic content information without previously transmitting a request for the electronic content information. For example, content server 104 can periodically push or download electronic content information to peripheral device 102, and content delivery module 110 can then submit the electronic content information for delivery. As another example, content server 104 can periodically push or download electronic content information to peripheral device 102, and peripheral device 102 can store the received electronic content information on a coupled storage medium. Subsequently, content delivery module 110 can retrieve the electronic content information from the coupled storage medium. If the appropriate electronic content information is not found in the coupled storage medium, content delivery module 110 can transmit a request for the electronic content information to content server 104.

In another embodiment, content delivery module 110 contains program logic to retrieve electronic content information based on user identification information. The user identification information can be received, for example, from a user (e.g., through either input device 114 or sensor module 116), received as part of a processing request (e.g., a print request can contain user identification information as part of the protocol data), and/or one or more other coupled modules and components. The request is transmitted to one or more content servers 104 through communication network 106. A responding content server 104 processes the request and transmits electronic content information based on the user identification to peripheral device 102. Content delivery module 110 receives the electronic content information and submits the electronic content information for delivery by content delivery device 108 upon determining, for example, that content delivery device 108 is idle and thus, capable of delivering the electronic content information.

In still another embodiment, content delivery module 110 contains program logic to retrieve electronic content based on the type of peripheral device 102. The request for electronic content information may contain information such as, by way of example, peripheral device 102 type, make, and model. Content server 104 receives and processes the request and transmits electronic content information appropriate for the particular peripheral device 102. In other embodiments, content delivery module 110 contains program logic to retrieve electronic content information based on physical location information, peripheral device 102 owner information, primary user information, electronic content information, category information, user preferences, past orders, and other information and data appropriate for use in targeting electronic content information.

In one embodiment, content delivery module 110 contains program logic to store the received electronic content information in local memory such as local cache memory in peripheral device 102. Subsequently, content delivery module 110 can check the local memory for electronic content information before transmitting a request to one or more content servers 104.

In another embodiment, content delivery module 110 contains program logic to process the ordering of products and/or service offered through peripheral device 102. In response to a user ordering a product or service, content delivery module 110 can request and receive the appropriate identification information (e.g., user identification, account identification, etc.). For example, the request for the identification information can be made through content delivery device 108, and the requested identification information can be received through input device 114 or sensor module 116. The identification information is used to identify the purchaser and appropriately charge the purchaser for the product or service. Content delivery module 110 can then process the user's order by transmitting a purchase request to, for example, content server 104 or other coupled computer capable of processing the product order. The purchase request can include the requested product or service information and accounting information. In still another embodiment, the purchaser information (e.g., accounting and shipping information necessary to process product and service purchases) is maintained on peripheral device 102, for example on local storage unit 112. In other embodiments, purchaser information is maintained on content server 104 or other computers configured to process product or service purchase requests.

In one embodiment, content delivery device 108 and content delivery module 110 may be remotely coupled to peripheral device 102. For example, content delivery device 108 and content delivery module 110 may be externally coupled via a USB port, and the like, to a peripheral device 102 such as a printer. As another example, content delivery device 108 and content delivery module 110 may be coupled to peripheral device 102 using wireless technology.

In another embodiment, content delivery device 108, such as a display screen, may contain program logic or functionality to superimpose the status report of peripheral device 102 over the electronic content information. Accordingly, the delivery of electronic content information will not interrupt any status reports. In still another embodiment, content delivery device 108 may contain program logic or functionality to have more than one electronic content information delivered at the same time. By way of example, a display screen may be subdivided into a number of smaller screens for viewing multiple electronic content information.

Input device 114 facilitates the input of information to peripheral device 102. Examples of input devices 114 include, without limitation, a keypad, a touch screen, or a voice command recognition device. A user can provide information, such as user identification information, through input device 114. Input device 114 may be used to provide other input information or requests, such as, by way of example, a request to deliver electronic content information on a paper medium or via email. For example, input device 114 may have a button component for requesting the printing of the electronic content information delivered via content delivery device 108. A user can press the button to obtain a paper copy of the electronic content information.

Input device 114 may also allow the user to select alternative electronic content information for delivery. For example, if the user has selected more than one electronic content information category that he may be interested in (e.g., sports news, financial news, one or more stock prices, weather reports, etc.), the list containing the categories can be displayed on content delivery device 108. The user can then scroll through the list using one or more arrow button components and choose the electronic content information category for delivery by pressing a button. As other examples, a user can use input device 114 to request ordering of one or more product or service offers delivered through peripheral device 102, activate, deactivate, or change preferences regarding the delivery of electronic content information on peripheral device 102, and the like.

Sensor module 116 can facilitate the receiving of user identification information. Sensor module 116 can conform to the Bluetooth specification or other known wireless specification. In one embodiment, sensor module 116 can transmit requests to receive identification information from devices within range of receiving the transmitted request. Articles commonly carried by people such as, by way of example, mobile phones, pagers, cameras, watches, other portable electronic devices can contain components capable of receiving the request to transmit identification information. Subsequently, the article can transmit identification information to peripheral device 102, and in particular, sensor module 116. Content delivery module 110 can then use the received identification information to retrieve and deliver electronic content information appropriate for the identification information.

In another embodiment, sensor module 116 can facilitate the receipt of information (e.g., user identification, account number, credit or debit card number, etc.) that is used to facilitate purchases through peripheral device 102. For example, a user may have previously set up account information. Peripheral device 102 may maintain the account information in local memory, such as local storage unit 112, or the account information may be maintained on a coupled content server 104. Subsequently, the user may be provided an option to purchase a product or service offered through peripheral device 102. The user, wanting to purchase the product or service, can user a portable article, such as a wireless phone, to transmit information necessary to make the purchase. The transmitted information is received by sensor module 116. Peripheral device 102 can then use the received information to determine the associated account information and accordingly bill an associated account (e.g., credit card account, debit card account, department account, etc.).

Local storage unit 112 facilitates the storage of data and information on peripheral device 102. Local storage unit 112 can be implemented as volatile memory (e.g., RAM), nonvolatile memory (e.g., memory disk or stick), or a combination of both. Peripheral device 102 can locally store data and information on local storage unit 112.

In other embodiments, one or more aforementioned components of peripheral device 102 may reside in and execute, for example, on one or more computers. For example, content delivery device 108 and input device 114 may reside in and execute on peripheral device 102. One or more of the other components, in particular, content delivery module 110 can reside in and execute on content server 104 or other computing device. Here, content delivery module 110 can then pull the electronic content information and push this content, for example, over a communication connection (e.g., any combination of wireless connection, physical connection, satellite connection, etc.) to delivery device 108.

Content server 104 facilities the delivery of electronic content information. As depicted, content server 104 includes a content interface module 118, a content database 120, a user database 122, and a device database 124. Content interface module 118 contains program logic to facilitate communication with one or more modules and components of content server 104 and peripheral devices 102, for example, through communication network 106. Content interface module 118 also contains program logic to receive a request for electronic content information, retrieve the appropriate electronic content information, and transmit the requested electronic content information to a requester of the electronic content information.

In one embodiment, content interface module 118 retrieves generic or non-specific electronic content information. For example, the electronic content information is independent of the type of peripheral device 102, or the physical location of peripheral device 102. In other embodiments, content interface module 118 retrieves electronic content information based on information such as, by way of example, user identification, peripheral device 102 specific information (i.e., manufacturer, model, type, etc.), electronic content information category, and the like.

Content interface module 118 can also contain program logic to process product and service purchase requests. Content interface module 118 can maintain accounting information to appropriately charge purchasers for the product and service. The accounting information can be maintained on content server 104 or one or more other computers that are accessible to content interface module 118. The accounting information can include, for example, purchaser identification, purchaser shipping information, purchaser account information, and the like. The purchaser identification may be associated with a user or department identification, and purchaser account information may be associated with a debit or credit card account, department account, or other information necessary to properly charge for the product or service.

Content database 120 contains identifiers respectively identifying one or more electronic content information. Content database 120 can also contain other information and data, such as, by way of example, information regarding the provider of the electronic content information, appropriate devices to receive the electronic content information, the type or category of electronic content information, and the like, for each electronic content information. When content delivery module 110 requests the retrieval of electronic content information from content server 104, content interface module 118 can retrieve the appropriate electronic content information from content database 120.

User database 122 contains user identification information. For example, user database 122 may have, for each user identification, a listing of electronic content information that is appropriate for the particular user associated with each user identification. Also, user database 122 may contain a user's accounting information for ordering any products or services. When content delivery module 110 requests the retrieval of electronic content information based on a user identification from content server 104, content interface module 118 can use the data in user database 122 to retrieve the electronic content information appropriate for the user identification.

Device database 124 contains information regarding one or more peripheral devices 102 that are coupled to content server 104. Device database 124 contains information to identify each peripheral device 102. Device database 124 also contains information regarding each peripheral device 102, and this information can be used to identify electronic content information appropriate for a particular peripheral device 102. For example, when content delivery module 110 requests the retrieval of electronic content information based on device information from content server 104, content interface module 118 can use the data in device database 124 to retrieve the electronic content information appropriate for the requesting peripheral device 102.

One of ordinary skill in the art will appreciate that the functionality provided by the components, devices, databases, and modules of peripheral device 102 and content server 104, may be combined into fewer components or devices or databases or modules or further separated into additional components, devices, databases, and modules. For example, content delivery module 110 and content interface module 118 may be combined together to perform the same function or further separated into additional modules performing the same function. Additionally, some of the components, devices, databases, and modules may be optional and not provided. For example, local storage unit 112, input device 114, sensor module 116, user database 122, and device database 124 are optional.

Referring again to FIG. 1, communication network 106 couples peripheral device 102 and content server 104. Communication network 106 may include, by way of example, local area networks (LANs), wide area networks (WANs), public internets, private intranets, a private computer network, a secure internet, a private network, a public network, a value-added network, interactive television networks, wireless data transmission networks, two-way cable networks, satellite networks, interactive kiosk networks, and/or any other suitable data network.

In one embodiment, communication network 106 includes the Internet. The Internet is a global network connecting millions of computers, including content server 104. The structure of the Internet, which is well known to those of ordinary skill in the art, is a global network of computer networks and utilizes a simple, standard common addressing system and communications protocol known as Transmission Control Protocol/Internet Protocol (TCP/IP). The connections between different networks are called “gateways,” and the gateways serve to transfer electronic content information worldwide.

One part of the Internet is the World Wide Web (WWW or Web). The Web is generally used to refer to both (1) a distributed collection of inter-linked, user-viewable hypertext documents (commonly referred to as “web documents” or “web pages” or “electronic pages” or “home pages”) that are accessible via the Internet, and (2) the user and server components which provide user access to such documents using standardized Internet protocols. The web documents are encoded using Hypertext Markup Language (HTML) and the primary standard protocol for allowing the components to locate and acquire web documents is the Hypertext Transfer Protocol (HTTP). However, as used herein, the term Web is intended to encompass future languages and protocols which may be used in place of, or in addition to, HTML and HTTP.

The Web contains different computers that store and serve web pages, such as HTML documents, capable of displaying textual and graphical information on a computer screen. These computers are generally referred to as “web sites.” A web site is accessed through a unique Internet address that corresponds to a web page within the web site. The web page may advantageously organize the presentation of text, graphical images, video, and audio, as well as provide links to other web pages in the web site or the Web. Furthermore, the web page may be implemented as a conduit for the dissemination of data and information from the web site as well as the receipt of data and information into the web site.

One of ordinary skill in the art will appreciate that the Internet web pages may be delivered to content delivery device 108. When content delivery module 110 requests the retrieval of electronic content information from content server 104, content interface module 118 in content server 104 determines the appropriate electronic content information from content database 120 and submits the appropriate electronic content information to content delivery module 110. If the electronic content information is an Internet web page, content interface module 118 retrieves the electronic content information via the content database 118. Upon receiving the appropriate electronic content information, content delivery module 110 submits the electronic content information for delivery via content delivery device 108.

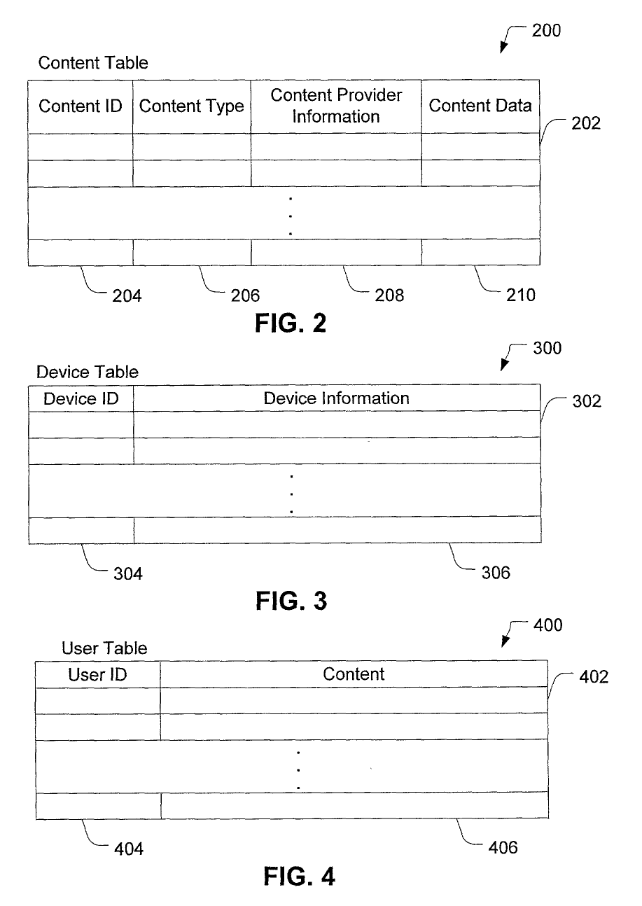

Exemplary tables of information contained in content database 120, device database 124, and user database 122 are provided in FIGS. 2, 3, and 4, respectively. FIG. 2 illustrates an exemplary content table 200, according to one embodiment. Content table 200 contains electronic content information and information and data related to the electronic content information. Content table 200 contains one or more content table records 202 and each content table record 202 contains information associated with an electronic content information. By way of example, in each content table record 202, four fields are illustrated comprising a content ID field 204, content type field 206, content provider information field 208, and content data field 210.

Content ID field 204 contains an identifier that identifies the associated electronic content information. Content type field 206 contains one or more descriptors or identifiers that indicates the type or category of the associated electronic content information. For example, the descriptors may categorize the electronic content information as advertising, news, company alerts, product offers, service offers, service alerts, and the like. The descriptors may further categorize the electronic content information into sub-categories. For example, advertising may be further sub-categorized into clothing, accessories, computers, electronics, sports equipment, gifts, flowers, home and garden, toys, and the like. Likewise, news may be further sub-categorized into top stories, business, technology, sports, entertainment, traffic, weather, classifieds, and the like.

Content provider information field 208 contains information related to and about the provider of the associated electronic content information. For example, content provider information field 208 can contain name, address, and contact information for a company that is providing the associated electronic content information. Content provider information field 208 can also contain price information for electronic content information that is a product or service offer. Content data field 210 contains the electronic content information or a reference to the electronic content information. For example, content data field 210 can contain a hyperlink to a network resource containing the electronic content information.

FIG. 3 illustrates an exemplary device table 300, according to one embodiment. Device table 300 contains information regarding peripheral devices 102 that communicate with and request electronic content information from content server 104. Device table 300 contains one or more device table records 302, and each device table record 302 contains information associated with a peripheral device 102. By way of example, in each device table record 302, two fields are illustrated comprising a device ID field 304 and a device information field 306.

Device ID field 304 contains an identifier that identifies a peripheral device 102. For example, this identifier can be included in a request for electronic content information that is received by content server 104. Content interface module 118 can use this information to identify the appropriate device table record 302 in device table 300, and subsequently retrieve the electronic content information for the requesting peripheral device 102.

Device information field 306 contains information regarding peripheral device 102 identified by the identifier stored in the associated device ID field 302. Device information field 306 can include information such as, by way of example, type of peripheral device 102 (e.g., printer, fax machine, copier, etc.), make and model of peripheral device 102, type of users of peripheral device 102, information regarding the owner of peripheral device 102, location of peripheral device 102, reference to one or more electronic content information appropriate for peripheral device 102, and use history of peripheral device 102 (e.g., printing profiles, ad response history, etc.). For example, content interface module 118 can determine the electronic content information appropriate for a particular peripheral device 102 from the contents of device information field 306.

FIG. 4 illustrates an exemplary user table 400, according to one embodiment. User table 400 contains information regarding one or more users of peripheral devices 102 that request electronic content information from content server 104. User table 400 contains one or more user table records 402, and each user table record 402 contains information associated with a user of peripheral device 102. By way of example, in each user table record 402, two fields are illustrated comprising a user ID field 404 and a content field 406.

User ID field 404 contains an identifier that identifies a user of peripheral device 102. For example, this identifier can be included in a request for electronic content information that is received by content server 104. Content interface module 118 can use this information to identify the appropriate user table record 402 in user table 400, and subsequently retrieve the electronic content information appropriate for the identified user. In one embodiment, user ID field 404 can also contain information, such as, by way of example, user preferences, user name and address, user accounting information, user tendency information, and the like. In another embodiment, user ID field 404 can contain a reference to one or more records that contain some or all of the aforementioned user information.

Content field 406 contains information regarding the electronic content information appropriate for the user identified by the user identification stored in the associated user ID field 404. For example, content field 406 can contain one or more identifiers that are stored in content ID field 204 in content table 200. The identifiers can be used to identify and retrieve the associated electronic content information.

According to an embodiment of the present invention, content interface module 118 determines the electronic content information specific to a user by looking up the user's identification in user ID field 404 and the contents of the corresponding content field 406. Content interface module 118 can then use the contents of content field 406 to identify and retrieve the electronic content information from content table 200. The retrieved electronic content information is then delivered, for example, through content delivery module 110 and content delivery device 108 of peripheral device 102.

Method for Delivering Electronic Content Information

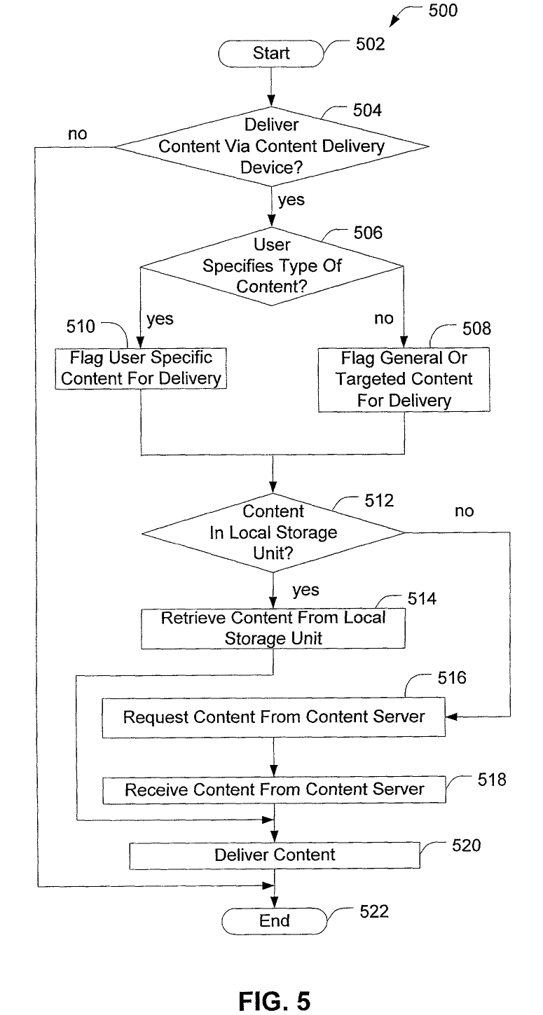

FIG. 5 is a flow chart of an exemplary method 500 for delivering electronic content information to through a peripheral device 102, according to one embodiment. Beginning at a start step 502, peripheral device 102 receives a request to perform or process a task. Depending on the type of peripheral device 102, the task may be, for example, a request to print a document, a request to send or receive a fax, a request to make copies, and the like. The task may also be a request to deliver electronic content information from sensor module 116 or a request to deliver electronic content information from input device 114.

At step 504, content delivery module 110 of peripheral device 102 determines if it is appropriate to deliver electronic content information via content delivery device 108. For example, content delivery module 110 determines if content delivery device 108 is idle and available to deliver electronic content information. If content delivery device 108 is not available to deliver electronic content information, content delivery module 110 ends at step 522. If content delivery device 108 is available to deliver electronic content information, content delivery module 110 determines if, for example, a user specified a desired type of electronic content information at step 506.

If, at step 506, it is determined that the user did not specify a desired type of electronic content information, content delivery module 110 flags the retrieval of general or targeted electronic content information at step 508. Here, the targeted content is content that may be based on the information associated with peripheral device 102. If, at step 506, it is determined that the user specified a desired type of electronic content information, content delivery module 110 flags the retrieval of user specified or specific electronic content information at step 510. Foe example, the user may have previously indicated his or her preference of electronic content information through one or more set-up menus provided with peripheral device 102. At step 512, content delivery module 110 determines if the appropriate electronic content information is locally stored, for example, in local storage unit 112.

If, at step 512, the appropriate electronic content information is stored in local storage unit 112, content delivery module 110 retrieves the electronic content information from local storage unit 112 at step 514. If, at step 512, the appropriate electronic content information is not stored in local storage unit 112, content delivery module 110 sends a request for the appropriate electronic content information to content server 104 at step 516. Content interface module 118 in content server 104 determines and retrieves the requested electronic content information and transmits it to peripheral device 102.

In one embodiment, the request for electronic content information includes necessary identification information (e.g., user identification, peripheral device identification, electronic content category information, etc.) to enable content interface module 118 to process the request for electronic content information. For example, if the request is for user specific electronic content information, the request can include user identification information. In another embodiment, the electronic content information may be a general or generic request, in which case, content interface module 118 is free to determine what electronic content information to transmit.

At step 518, content delivery module 110 in peripheral device 102 receives the requested electronic content information transmitted by content server 104. In one embodiment, content delivery module 110 can store the electronic content information in local storage unit 112. At step 520, content delivery module 110 utilizes content delivery device 108 to deliver the electronic content information (retrieved from local memory (step 514) or received from content server 104 (step 518)) and ends at step 522. In another embodiment, content server 104 can transmit (e.g., push or download) electronic content information and peripheral device 102 can filter the received electronic content information, for example, to match a user's preferences, before delivering the filtered electronic content information to the user.

One of ordinary skill in the art will appreciate that, for this and other methods disclosed herein, the functions performed in the exemplary flow chart may be implemented in differing order. Furthermore, steps outlined in the flow charts are only exemplary, and some of the steps may be optional, combined into fewer steps, or expanded into additional steps without detracting from the invention.

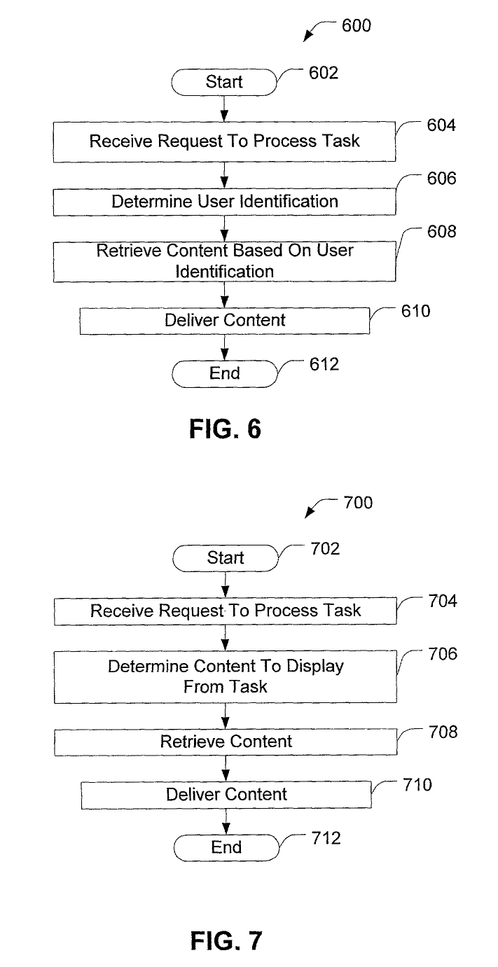

FIG. 6 is a flow chart of an exemplary method 600 for delivering electronic content information based on user identification, according to one embodiment. Beginning at a start step 602, a user requests, for example, to perform a task on peripheral device 102 such as fax a document. At step 604, peripheral device 102 receives the request to process the task (i.e., the request to fax the document).

At step 606, content delivery module 110 in peripheral device 102 determines the user identification associated with the task. In one embodiment, the user identification associated with the task may be included as part of the request to perform the task. In the fax example, the user may have been required to submit user identification information as part of faxing the document. In another embodiment, peripheral device 102 can request user identification information as part of processing the task. In the fax example, the fax machine can request user identification information from the user as part of processing the task. If the user provides a user identification information, the fax machine can use the provided identification information in retrieving and delivering electronic content information appropriate for the user identification. If the user fails to provide identification information, for example, within a predetermined time period, the fax machine can retrieve and deliver generic electronic content information.

At step 608, assuming that content delivery module 110 was able to determine the user identification information, content delivery module 110 retrieves electronic content information based on the user identification information. The electronic content information may be retrieved from local storage unit 112 or content server 104. In one embodiment, content delivery module 110 can include the user identification information as part of a request to content server 104 for electronic content information. Content server 104 can then determine and transmit electronic content information appropriate for the identified user. In another embodiment, content delivery module 110 can request electronic content information from content server 104. Upon receiving the electronic content information, content server 104 can determine the electronic content information appropriate for the identified user. At step 610, content delivery module 110 utilizes content delivery device 108 to deliver the appropriate electronic content information, and ends at step 612.

FIG. 7 is a flow chart of an exemplary method 700 for delivering electronic content information based on the contents of a document that is being processed, according to one embodiment. Beginning at a start step 702, a user requests, for example, to perform a task on peripheral device 102 such as print a document. At step 704, peripheral device 102 receives the request to process the task (i.e., the request to print the document). At step 706, content delivery module 110 in peripheral device 102 identifies or classifies the type of content contained in the document. Content delivery module 110, for example, may determine the document's content type by scanning the document contents for certain words or phrases that provides clues as to the content type. Content delivery module 110 may also determine the document's content type from the document's filename or filename extension (e.g., .doc, .pdf, .xls, .vsd, etc.). At step 708, content delivery module 110 retrieves electronic content information based on the type of document contents.

In one embodiment, content delivery module 110 can issue a request for the appropriate electronic content information (e.g., specify the desired electronic content information as part of the request) from content server 104. Content server 104 can then retrieve and transmit the requested electronic content information to peripheral device 102. In another embodiment, content delivery module can request electronic content information from content server 104, and as part of the request, include the document contents. Content server 104 can then determine from the document contents the appropriate electronic content information, and transmit the electronic content information to peripheral device 102. At step 710, content delivery module 110 utilizes content delivery device 108 to deliver the appropriate electronic content information, and ends at step 712.

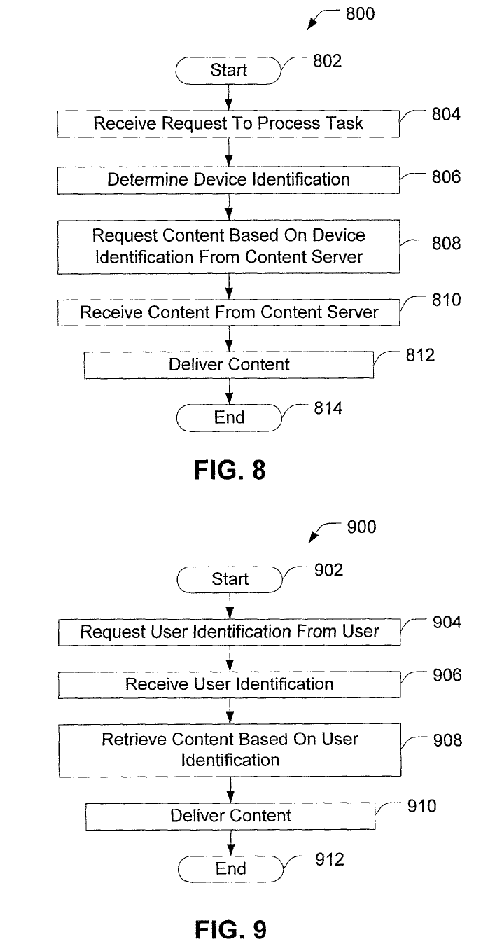

FIG. 8 is a flow chart of an exemplary method 800 for delivering electronic content information based on device identification, according to one embodiment. Beginning at a start step 802, a user request, for example, to perform a task on peripheral device 102 such as photocopy a document. At step 804, peripheral device 102 receives the request to process the task (i.e., photocopy one or more pages of the document).

At step 806, content delivery module 110 in peripheral device 102 determines the device identification associated with peripheral device 102. For example, the device identification can generally identify peripheral device 102 as a copier, and can further identify the make and model of the copier as well as other information associated with the copier, such as the owner of the copier, the type of user of the copier, and the like. The device identification information identifies the appropriate electronic content information for the particular peripheral device 102.

At step 808, content delivery module 110 requests electronic content based on device identification information from content server 104. The device identification information can be included as part of the request for electronic content information. Content server 104 uses the device identification included as part of the request to identify the appropriate electronic content information and transmits the electronic content information to peripheral device 102. At step 810, content delivery module 110 in peripheral device 102 receives the requested electronic content information from content server 104. At step 812, content delivery module 110 utilizes content delivery device 108 to deliver the received electronic content information, and ends at step 814.

FIG. 9 is a flow chart of an exemplary method 900 for delivering electronic content information based on detecting a user, according to one embodiment. Beginning at a start step 902, sensor module 116 in peripheral device 102 detects that a user is in the proximity of peripheral device 102. A user may be carrying an electronic device, such as, by way of example, a wireless phone, PDA, pager, smartcard, employee ID badge, or other portable device, that is capable of detection by sensor module 116. For example, a user carrying such as device may be waiting in the proximity of a printer waiting for a print job to print.

At step 904, sensor module 116 on peripheral device 102 can transmit a request for a user identification information for reception by the detected electronic device. The electronic device can transmit identification information to identify the device, and in particular, the owner of the device (e.g., the user). In another embodiment, peripheral device 102 can display a request for user identification information on, for example, a coupled display device. The user can then enter user identification information using input device 114.

At step 906, sensor module 116 receives the user identification information from the electronic device. At step 908, sensor module retrieves the electronic content information based on the user identification information. At step 910, content delivery module 110 utilizes content delivery device 108 to deliver the appropriate electronic content information, and ends at step 912. Thus, peripheral device 102 can deliver electronic content information that is of interest to the user.

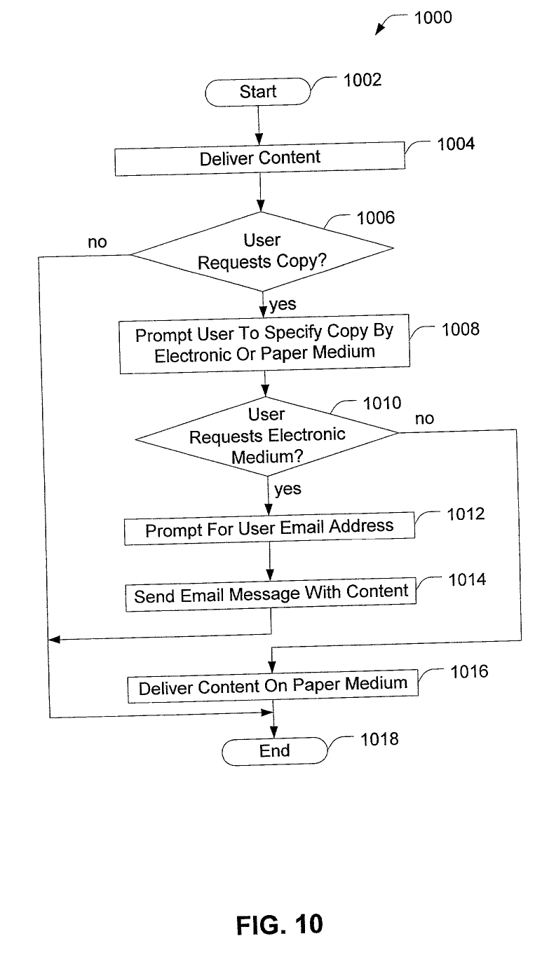

FIG. 10 is a flow chart of an exemplary method 1000 for providing a copy of the electronic content information, according to one embodiment. Beginning at a start step 1002, peripheral device 102 has retrieved electronic content information for delivery via content delivery device 108. At step 1004, content delivery device 108 delivers the electronic content information. For example, a notice for an upcoming company event can be delivered by being displayed on content delivery device 108. At step 1006, peripheral device 102 determines if a user requests a copy of the electronic content information that is delivered via content delivery device 108.

In one embodiment, peripheral device 102 can provide a button, for example, on input device 114 through which the user can request a copy of the displayed electronic content information. If the user does not request a copy of the electronic content information, peripheral device 102 ends at step 1018. If the user does request a copy of the electronic content information, peripheral device 102 prompts the user to specify the type of medium for delivery at step 1008. For example, peripheral device 102 may provide an option to receive a paper copy or an electronic copy of the electronic content information. The electronic medium may, by way example, be an electronic mail (“email”). The content of the copy delivered may contain an excerpt, a summary, or all of the electronic content information. The content of the copy delivered may also contain a derivative of the electronic content information, such as, by way of example, coupons on advertisements for products or services. The user can select the medium type by using input device 114 such as a keypad, touch pad, voice command recognition device, etc.

At step 1010, peripheral device 102 determines if the user selected to receive a copy of the electronic content information via electronic medium. If the user selected delivery via an electronic medium, then, at step 1012, peripheral device 102 (i.e., content delivery module 110 in peripheral device 102) prompts the user to input an email address. At step 1014, peripheral device 102 can send an email message containing all or a part of the electronic content information to the specified email address, and ends at step 1018. In another embodiment, peripheral device 102 can provide an option for the user to specify a filename for a destination file that is to receive the electronic content information.

If, at step 1010, peripheral device 102 determined that the user did not select to receive an electronic copy, but, rather, selected to receive a paper copy, peripheral device 102 delivers the electronic content information on paper medium. For example, peripheral device 102 can print the electronic content information on one or more sheets of paper. Having delivered a paper copy of the electronic content information, peripheral device 102 ends at step 1018.

In one embodiment, when the user selects to receive a copy of the electronic content information or receive more detailed information related to the electronic content information, the provider of the electronic content information is appropriately billed for delivering the requested electronic content information. For example, a computer advertisement may be delivered on peripheral device 102, and the user, upon viewing the advertisement, may request a printed copy. Assuming that the computer manufacturer contracted with, for example, the provider of content server 104 to deliver its advertisements for a fee, the provider of content server 104 can charge the computer manufacturer for delivering the printed copy of the computer advertisement.

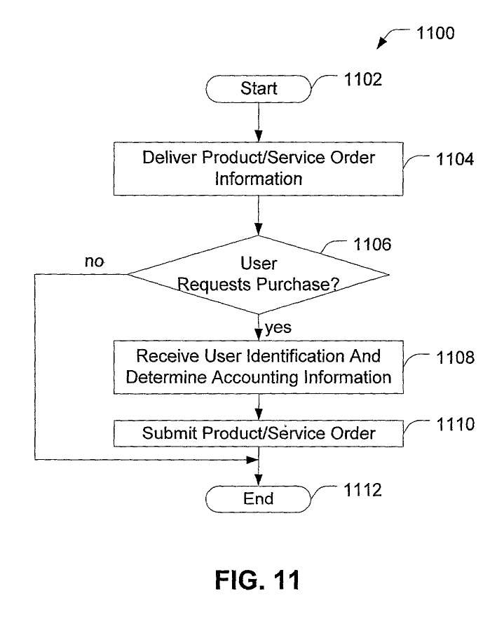

FIG. 11 is a flow chart of an exemplary method 1100 for ordering a product or service, according to one embodiment. Beginning at a start step 1102, peripheral device 102 has retrieved electronic content information for delivery via content delivery device 108. At step 1104, content delivery device 108 in peripheral device 102 delivers the electronic content information. For example, the electronic content information can be an offer to purchase a product or service. At step 1106, peripheral device 102 determines if a user requests to purchase the offered product or service. If peripheral device 102 does not receive a request to purchase the offered product or service, peripheral device 102 ends at step 1112.

If peripheral device 102 receives a request to purchase the offered product or service, peripheral device 102 can prompt the user for identification information. Peripheral device 102 can maintain a table of user identifications and its respective account information (e.g., account number, shipping address, name, etc.). For example, peripheral device 102 can display a request for user identification information on a screen coupled to peripheral device 102. In another embodiment, peripheral device 102 can prompt the user to provide an account number to charge the cost or fee of the requested product or service. At step 1108, peripheral device 102 receives the user identification information. For example, the user may enter the user identification information through input device 114 in peripheral device 102. As another example, the user can use an electronic device to transmit the user identification information to peripheral device 102. Sensor module 116 in peripheral device 102 can then receive the transmitted user identification information.

At step 1110, content delivery module 110 in peripheral device 102 submits a request to purchase the offered product or service, and ends at step 1112. The request to purchase the offered product or service is transmitted to a computer configured to process the purchase request. For example, if user identification information was requested and received, content delivery module 110 can determine the account information associated with the user identification. The account information can then be included in the request to purchase the offered product or service. Alternatively, if an account number was received, the received account number can be included in the request to purchase the offered product or service.

In another embodiment, content server 104 can maintain a table of user identifications and its respective account information. Content delivery module 110 can then transmit a request to purchase the offered product or service to content server 104. The request can include a user identification information, and content server 104 can use the user identification information to determine the appropriate account information to charge for the cost of the requested product or service.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

What is claimed is:

1. A peripheral device operable to be coupled to a computer communication network, the peripheral device comprising:
a content delivery device operable to deliver electronic content information; and
a content delivery module coupled to the content delivery device and operable to retrieve the electronic content information, the content delivery module further operable to determine an appropriate time to deliver the electronic content information, and operable to deliver the electronic content information via the content delivery device.

2. The peripheral device of claim 1, wherein the content delivery device is a display screen for visual content delivery.

3. The peripheral device of claim 1, wherein the content delivery device is a speaker for auditory content delivery.

4. The peripheral device of claim 1, wherein the content delivery device is remotely coupled to the peripheral device.

5. The peripheral device of claim 1, wherein the content delivery module is remotely coupled to the peripheral device.

6. The peripheral device of claim 1, wherein the content delivery module retrieves the electronic content information from a remote content server.

7. The peripheral device of claim 1, wherein the content delivery module retrieves the electronic content information from a local storage unit.

8. The peripheral device of claim 1, wherein the electronic content information is determined from a user identification.

9. The peripheral device of claim 1, further comprising an input device for receiving user input.

10. The peripheral device of claim 1, further comprising a sensor module operable to receive transmissions from a remote electronic device.

11. The peripheral device of claim 10 wherein the sensor module is further operable to detect an electronic device within its proximity.

12. The peripheral device of claim 1 wherein the appropriate time being substantially when the content delivery device is idle.

13. A peripheral device operable to be coupled to a computer communication network, the peripheral device comprising:
a content delivery device operable to deliver electronic content information;
a first means for determining an appropriate time to deliver the electronic content information;
a second means for retrieving the electronic content information; and
a third means for delivering electronic content information via the content delivery device.

14. The peripheral device of claim 13, further comprising an input device for receiving user input.

15. The peripheral device of claim 13, further comprising a third means for detecting user identification information, wherein the user identification information is used to retrieve electronic content information.

16. In a peripheral device, a method of delivering electronic content information comprising:
retrieving electronic content information;
determining when a content delivery device coupled to the peripheral device is idle; and
responsive to determining that the content delivery device is idle, delivering the electronic content information via the content delivery device.

17. The method of claim 16, wherein the content delivery device is a speaker for auditory electronic delivery.

18. The method of claim 16, wherein the content delivery device is a display screen for visual electronic delivery.

19. The method of claim 16, further comprising:
determining a user identification; and
responsive to determining a user identification, retrieving the electronic content information associated with the user identification.

20. The method of claim 19, further comprising determining accounting information associated with the user identification for placing product or service orders.

21. The method of claim 16 wherein the electronic content information is determined from a document's contents.
